(19) United States
(12) Patent Application Publication
(10) Pub. No.: US 2015/0231663 A1
(43) Pub. Date: Aug. 20, 2015

(54) APPARATUS FOR DIRECTLY APPLYING LIQUID TO A SUBSTRATE

(71) Applicant: Rainbow Technology Systems Limited, Glasgow (GB)

(72) Inventors: Jonathan Kennett, Glasgow (GB); John Cunningham, Glasgow (GB); Robert Gibson, Glasgow (GB)

(21) Appl. No.: 14/358,690

(22) PCT Filed: Nov. 15, 2012
(86) PCT No.: PCT/GB12/52829

§ 371 Date: May 15, 2014

(51) Int. Cl. B05C 11/10; B05C 9/12; B05C 9/10; B05C 5/02; B05C 11/02

(52) U.S. Cl. CPC B05C 11/1021; B05C 5/0245; B05C 11/025; B05C 11/1039; B05C 9/10; B05C 9/12

(57) ABSTRACT

There is herein described apparatus and method for directly coating a liquid onto a substrate. More particularly, there is described an apparatus and method for directly coating a liquid onto a substrate where a programmable traversing dispensing head facilitates controlled dispensing of a liquid wet material with respect to size, shape, position, quantity, width and/or length.

### FIELD OF THE INVENTION

The present invention relates to an apparatus and method for directly coating a liquid onto a substrate. More particularly, the present invention relates to an apparatus and method for directly coating a liquid onto a substrate where, a programmable traversing dispensing head facilitates controlled dispensing of a liquid wet material with respect to size, shape, position, quantity, width and/or length.

### BACKGROUND OF THE INVENTION

There are many previously known coating techniques but these suffer from a number of disadvantages such as open ducts allowing contamination of the liquid material prior to being deposited. In addition, prior coating techniques comprise bars or rollers coated with liquid over their entire width—meaning that they are unable to control the size of area being coated. Previous coating techniques also suffer from the liquid becoming contaminated with dust or being exposed to light and the surrounding atmosphere prior to being deposited. A further disadvantage of previous coating techniques is that they suffer from the significant problem of liquid spills where the liquid spills over the edge of the substrate being coated.

It is an object of at least one aspect of the present invention to obviate or mitigate at least one or more of the aforementioned problems.

It is a further object of at least one aspect of the present invention to provide an improved apparatus for directly coating a liquid onto a substrate.

It is a further object of at least one aspect of the present invention to provide an improved method for directly coating a liquid onto a substrate.

### SUMMARY OF THE INVENTION

According to a first aspect of the present invention there is provided apparatus for directly coating a liquid onto a substrate, said apparatus comprising:

conveying means capable of conveying a substrate to a device capable of directly coating liquid wet material onto a surface of the substrate to form a film of liquid wet material;

a sensing system capable of determining the area to be coated with the liquid wet material; and

conveying the substrate with the film of liquid wet material to a drying device capable of drying the liquid wet material on the substrate.

Generally speaking, the present invention resides in the provision of an apparatus and method capable of directly applying a thin coating of liquid wet material onto a substrate using a programmable traversing dispensing head. The programmable traversing dispensing head facilitates controlled dispensing of the liquid wet material with respect to size, shape, position, quantity, width and/or length. The apparatus of the present invention is also suitable for coating sheets or reel to reel applications.

The liquid wet material is preferably clear but in alternative embodiments the liquid wet material may be coloured e.g. a blue colour.

By directly coating (i.e. depositing) means that only the amount required for coating the substrate is supplied and used. No excess liquid wet material is therefore used. Prior art systems re-circulate liquid wet material fluid which at some time is exposed to the atmosphere. In contrast, the direct depositing in the present invention ensures that the liquid wet material is in an enclosed circulation system which is never exposed to atmosphere except at the point of deposition. There are also no dust or oxidation problems in the present invention due to the present system being in a completely enclosed environment.

The substrate may be provided in separate sheets or alternatively may be supplied in a continuous reel form and then optionally after being coated with liquid wet material and imaging rolled back into a roll form.

The sensing system of the present invention may be programmable which allows accurate deposition of the liquid wet material to occur. This allows the present invention to prevent liquid spills over the edge of a substrate being coated. The sensing system of the present invention allows the size, shape, position, quantity, width and/or length of the liquid deposition to be adjusted and adapted for a range of different requirements. For example, the liquid wet material may be deposited in a range of sizes from 1 cm×1 cm up to 3 m×6 m.

The sensing system may be programmable thereby allowing controlled dispensing of the liquid wet material. The sensing system of the present invention is suitable for coating sheets or for reel to reel applications.

The device capable of depositing liquid wet material may comprise coating head sensors located on either side of a dispensing system. The coating head sensors may locate the edges of the substrate to be coated and limit the period of dispensing from the coating head to ensure that the coating liquid is dispensed only within the boundary of the material to be coated. The dispensing system may also comprise a liquid dispensing tip which is capable of dispensing liquid in a controlled manner. This process may therefore use a Meyer bar method or roller for coating the liquid wet material. The apparatus of the present invention therefore supports the substrate being coated in sheet form on a moving conveyor made of any suitable material such as, for example, film, paper or any other material. Alternatively, the apparatus may operate on a reel to reel principle such that the material forming the conveyor may be rewound and reused. The apparatus may supply liquid wet material using a coating head arrangement comprising a dispensing head which may track across the coating bar. The dispensing head may be activated with pneumatics, electrics or both and dispense a pre-calculated bead of coating liquid on, for example, the tangent point between the substrate and the coating bar. Alternatively, the bead of coating liquid may be dispensed behind the tangent point in the situation where a reversing roller action is used with a roller or Meyer bar. The coating head arrangement may also detect the end of the substrate and thus stop the dispensing of the liquid wet material.

In alternative embodiments the device capable of directly depositing a liquid wet material may comprise a set of application rollers, a set of valves or a combination of both. The application rollers or valves may be located substantially vertical or horizontal to one another depending on whether vertical or horizontal deposition of liquid wet material is required onto a substrate. The device may also comprise a pump capable of feeding liquid wet material to a pressure regulator. There may also be liquid dispensing tips which may be static or may traverse the application rollers or valves. The device may therefore apply liquid wet material vertically or horizontally to a substrate located between the application rollers or valves depending on the orientation of the application rollers or valves.

The speed of the substrate being conveyed may be computer controlled. The computer control may also extend to the control of the size, shape, position, quantity, width and/or length of the liquid wet material being deposited.

The substrate may be any suitable substrate. In particular embodiments the substrate may be a web and may, for example, comprise a dielectric or non-metallic layer (e.g. a film) made from a plastics material such as polyester (e.g. Melinex-Trade Mark), polyimide (e.g. Kapton-Trade Mark) and polycarbonate (e.g. Lexan-Trade Mark). The substrate may be flexible to allow a reel to reel process to occur. On top of the plastics material there may be a further layer which may be in the form of a cladding. The cladding may be made from a conductive material such as copper, silver, gold, ITO, PEDOTT and the like. In embodiments where the substrate is supplied in separate sheet form, the substrate is conveyed to the device capable of depositing a liquid wet material onto the substrate and the drying device using a conveying material (e.g. a conveyor in the form of a belt). The conveying material may be capable of conveying the substrate from one side of the apparatus to the other. The conveying apparatus may comprise a support roller and a cleaning roller. The conveying apparatus may also comprise a take-up roller and a drive roller onto which the conveying material may be driven onto. Therefore, as the drive roller rotates, the conveying material may be rotated from an initial roll, over the support roll and then along the length of the apparatus and over the drive roller and onto the take-up roll. The substrate may therefore be conveyed on the conveying material from one side of the apparatus to the other allowing the deposition of the liquid wet material.

In alternative embodiments, the substrate may be supplied in a roll form, rather than a sheet, therefore forming a reel to reel process. The rolled substrate may initially be passed between a support roller and a cleaning roller. The cleaning roller is used to clean the surface of the unrolled part of the rolled substrate. The adhesive roller removes debris and/or contaminants from the cleaning roller. The cleaned substrate may then be passed to a coating head.

The substrate, in both the sheet and rolled form, may be fed through and between the support roller and the cleaning roller. The support roller may be substantially cylindrical in shape and may be made of any suitable plastics/composite/metal material. The cleaning roller may also be substantially cylindrical in shape and may be made from any suitable rubber or elastomeric type of material which is capable of removing debris and/or contaminants from a substrate surface to be cleaned.

The cleaning roller typically has a lower surface energy towards the contaminating particles than the adhesive roller. This means that the contaminating particles may form a temporary bond with the surface of the cleaning roller and may then be transferred to the adhesive roller which is urged and rotated against the cleaning roller. The adhesive roller removes debris and/or contaminants from the cleaning roller which is being used to clean a substrate surface which may be used in, for example, the manufacturing of electronics, photovoltaics and flat panel displays where the surfaces have to be extremely clean. The adhesive roller therefore cleans the surface of the cleaning roller to improve this process. The adhesive roller may be sheeted meaning that once the performance of the sheeted adhesive roller decreases then the used sheet can be removed exposing a new sheeted adhesive surface.

As the substrate, in both the sheet and rolled form, is fed between the support roller and the cleaning roller the surface intended to have liquid wet material deposited thereon may therefore be cleaned.

In the embodiment where the sheet is conveyed on the conveying material the sheet may be passed under a coating bar which may extend fully across the conveying material and the sheet as it passes underneath. The coating bar is capable of directly applying the liquid wet material. The device capable of depositing a liquid wet material may therefore be seen as a coating apparatus. The coating apparatus may also comprise a coating head which may be situated on a coating head transverse drive. In the embodiment where the substrate is in roll form the part of the roll that is unrolled is also passed under the coating bar.

The liquid wet material may be made up of 100% solids and contain no solvent. Alternatively, the liquid wet material may comprise less than 1% solvent, less than 5% solvent, less than 10% solvent or less than 50% solvent. The solvent may be water or a suitable organic liquid e.g. ethyl acetate.

Typically, the liquid material may be deposited with a thickness according to any of the following: less than or equal to about 150 μm; less than or equal to about 125 μm; less than or equal to about 100 μm; less than or equal to about 75 μm; less than or equal to about 50 μm; less than or equal to about 25 μm; less than or equal to about 10 μm; less than or equal to about 5 μm; less than or equal to about 1 μm; less than or equal to about 0.5 μm or less than or equal to about 0.1 μm. Alternatively, the liquid wet material may be deposited with a thickness ranging from any of the following: about 177 μm to about 0.1 μm; about 125 μm to about 0.1 μm; about 100 μm to about 0.1 μm; about 75 μm to about 0.1 μm; about 50 μm to about 0.1 μm; about 25 μm to about 0.1 μm or about 10 μm to about 0.1 μm. Preferably, the liquid wet material may have a thickness of about 4-5 microns.

By using thin liquid films this allows low intensity radiation (e.g. UV light) or any other suitable drying method to facilitate faster drying.

After the substrate has been coated with wet liquid material the coated substrate in sheet form may then be conveyed by the conveying material to the drying device. The drying device may be any suitable drying device such as a UV radiation source (e.g. a series of UV lamps, LEDs, lasers, etc.), an IR radiation source or any other energy source such as a heat source or hot air.

The apparatus described in the present invention can be fully contained in a self-contained mini-clean room which therefore provides significant cost savings in the coating process as the process need not be carried out in a large expensive clean room.

According to a second aspect of the present invention there is provided a method for directly coating a liquid onto a substrate, said method comprising:

providing conveying means capable of conveying a substrate to a device capable of directly coating liquid wet material onto a surface of a substrate to form a film of liquid wet material;

providing a sensing system capable of determining the area to be coated with the liquid wet material; and

conveying the substrate with the film of liquid wet material to a drying device capable of drying the liquid wet material on the substrate.

The method may use the apparatus as defined in the first aspect.

### BRIEF DESCRIPTION OF THE DRAWINGS

Embodiments of the present invention will now be described, by way of example only, with reference to the accompanying drawings in which:

FIG. 1 is a schematic view of apparatus capable of applying liquid wet material to sheets according to an embodiment of the present invention;

FIG. 2 is an expanded view of a coating head arrangement used in the apparatus shown in FIG. 1;

FIG. 3 is an expanded view of a coating bar in the coating head arrangement shown in FIG. 2;

FIG. 4 is a schematic view of apparatus capable of applying liquid wet material to rolls according to a further embodiment of the present invention;

FIG. 5 is an expanded view of a coating head used in the apparatus shown in FIG. 4;

FIG. 6 is a schematic view of further apparatus capable of applying liquid wet material to sheets using a vertical roller coating liquid dosing system according to an embodiment of the present invention; and

FIG. 7 is a schematic view of further apparatus capable of applying liquid wet material to sheets using a horizontal roller coating liquid dosing system according to an embodiment of the present invention.

### BRIEF DESCRIPTION

Generally speaking, the present invention resides in the provision of an apparatus and method capable of applying a thin coating of liquid wet material using a coating bar or rollers onto a substrate which is capable of being photoimaged or acting as a protective coating.

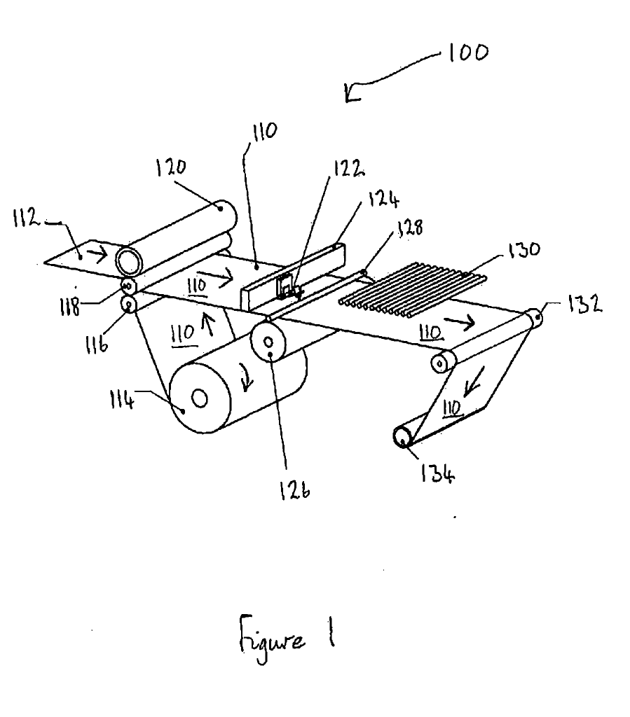

FIG. 1 is a representation of apparatus generally designated 100 according to the present invention. The apparatus 100 is capable of applying a thin layer of liquid wet material to sheets 112 (i.e. the substrate). Located towards the bottom of the apparatus 100 there is a roll 114 of conveying material 110 which is used to transport the sheet 112 from one end of the apparatus 100 to the other i.e. from the right- to the left-hand side of the apparatus 100. As shown in FIG. 1 the conveying material 110 is rotated between a support roller 116 and a cleaning roller 118. The support roller 116 and the cleaning roller are urged against one another. The support roller 116 is substantially cylindrical in shape and is made of any suitable plastics/composite/metal material. The cleaning roller 118 is also substantially cylindrical in shape and is made from any suitable rubber or elastomeric type of material which is capable of removing debris and/or contaminants from a surface of the sheet 112 to be cleaned. There is also shown an adhesive roller 120 located above and urged against the cleaning roller 118. The cleaning roller 118 typically has a lower surface energy towards the contaminating particles than the adhesive roller 120. This means that the contaminating particles may form a temporary bond with the surface of the cleaning roller 118 and may then be transferred to the adhesive roller 120 during rotation. The adhesive roller 120 therefore removes debris and/or contaminants from the cleaning roller 118 which is being used to clean a surface of the sheet 112 which may be used in, for example, the manufacturing of electronics, photovoltaics and flat panel displays where the surfaces have to be extremely clean. The adhesive roller 120 may be sheeted meaning that once the performance of the sheeted adhesive roller 120 decreases then the used sheet can be removed exposing a new sheeted adhesive surface underneath.

FIG. 1 also shows the sheet 112 being fed between the support roller 116 and the cleaning roller 118. As discussed above as the sheet 112 is fed between the support roller 116 and the cleaning roller 118 the surface of the sheet 112 intended to have liquid wet material deposited thereon is cleaned.

FIG. 1 also shows that the moving conveyor 110 is driven from the left- to the right-hand side of the apparatus 100. There is a take-up roll 134 and a drive roller 132 on the right-hand side of the apparatus 100. Therefore, as the drive roller 132 rotates the conveying material 110 is rotated from the roll 114 over the support roller 116 and along the length of the apparatus 100 and over the drive roller 132 and onto the take-up roll 134. The sheet 112 is therefore conveyed on the conveying material 110 from one side of the apparatus 100 to the other allowing the deposition of liquid wet material and thereafter drying to occur. The liquid wet material can therefore be dried using, for example, radiation from a drying device 130. It should be noted that any type of drying may be used.

As the sheet 110 is conveyed on the conveying material 110, the sheet 112 is passed over a supportive roller 126 and under a coating bar 128 which extends across the conveying material 110 and the sheet 112. There is also shown a coating head arrangement 122 which is situated on a coating head transverse drive 124.

Although not shown the apparatus 100 also comprises sensors which detect when a sheet 112 approaches the cleaning roller 118, the speed of the conveyed sheet 112 and when the sheet is approaching the coating bar 128. The system is therefore fully controllable allowing the system to track the location of the sheet 112.

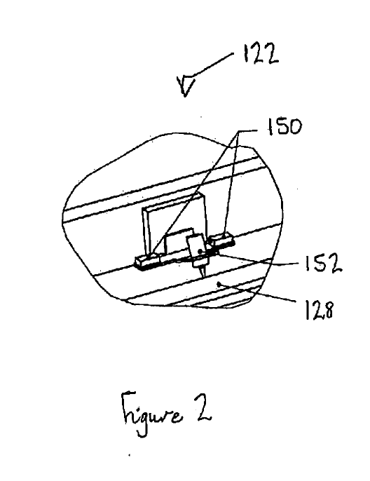

FIG. 2 is an expanded view of the coating head arrangement 122 and shows that there are coating head sensors 150 located on either side of a dispensing system 152. The operation of the coating head sensors 150 is programmable thereby allowing the position, size, shape, position, quantity, width and/or length of deposited liquid wet material to be carefully controlled.

The coating head sensors 150 locate the edges of the sheet 112 to be coated and limit the travel of the coating head arrangement 122 to ensure that the coating liquid is dispensed only within the boundary of the material to be coated. The coating head arrangement 122 therefore accurately dispenses the coating liquid to reduce the volume of liquid exposed and also decrease wastage. The dispensing system 152 comprises a liquid dispensing tip 154 which dispenses liquid in a controlled manner. This process therefore uses a Meyer bar method for coating the liquid wet material prior to curing. Usually, a Meyer bar rotates in a bath of the coating fluid and will likely have a doctor blade or such to calibrate the thickness of coating. To overcome previous problems found in the prior art, the apparatus 100 of the present invention supports the sheet 112 being coated in sheet form on a moving conveyor 110 made of, for example, film, paper or other material. This is on the reel to reel principle such that the material forming the conveyor 110 can be rewound and reused. This has advantages over a continuous belt which has more maintenance issues. It supports the sheet 112 right through the process and avoids any build-up of debris.

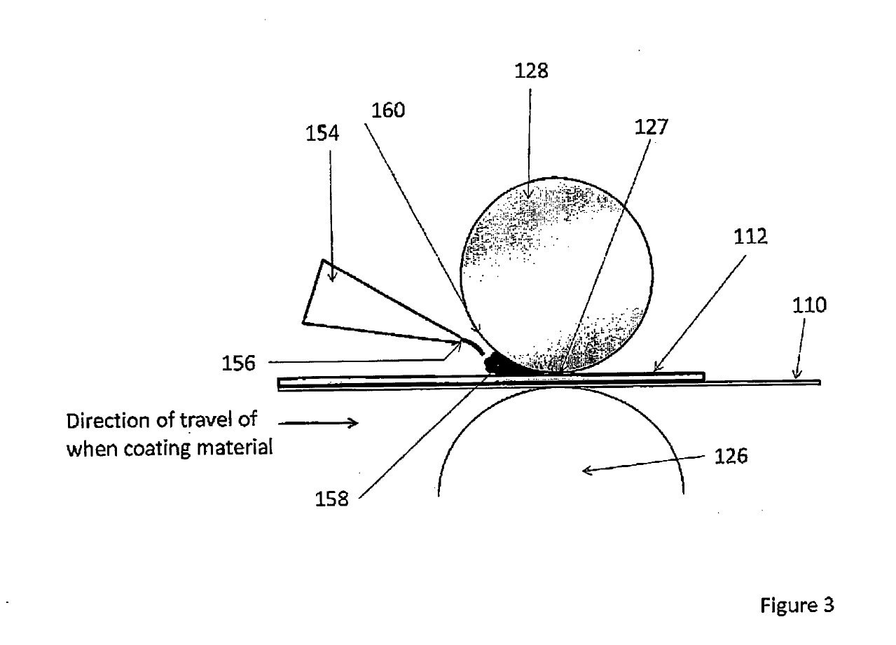

FIG. 3 shows that the dispensing tip 154 tracks adjacent the coating bar 128 depositing the liquid wet material in a continuous even manner. The dispensing tip 154 has an end 156 which is capable of depositing the liquid wet material into an area 158 in front of the tangential point 127 where the coating bar 128 makes contact with the substrate 112. The dispensing tip 154 may be activated with pneumatics, electrics or both (not shown) and is capable of dispensing a pre-calculated bead of coating liquid 158. The fluid then comes into contact with the front face 160 of the coating bar 128 and meets the sheet 112 to be coated. This ensures that there is always a meniscus of liquid wet material at the point of application sufficient to ensure a smooth and continuous coating on the sheet 112. The coating head arrangement 122 also detects the end of the sheet 112 and is therefore capable of stopping the dispensing of the liquid wet material. The substrate is, for example, coated with a liquid wet layer of material with a thickness of about 4-5 microns.

FIG. 3 also shows that the supportive roller 126 is perfectly parallel with the coating bar 128 i.e. the supportive roller 126 and the coating bar 128 are aligned with one another.

There are a number of advantages associated with the apparatus 100 of the present invention. For example, there is very little wastage of the coating liquid which is expensive. In addition, only the fluid being used is applied to the coating bar 128 and exposure to the atmosphere is very brief as it is only applied at the point of application. Moreover, spent fluid is never re-circulated or returned to a bulk storage vessel.

After the sheet 112 has been coated with liquid wet material the coated sheet 112 is then conveyed by the conveying material 110 to a drying source 130 (e.g. a series of UV lamps). The dried sheet 112 can then be collected and removed for further processing.

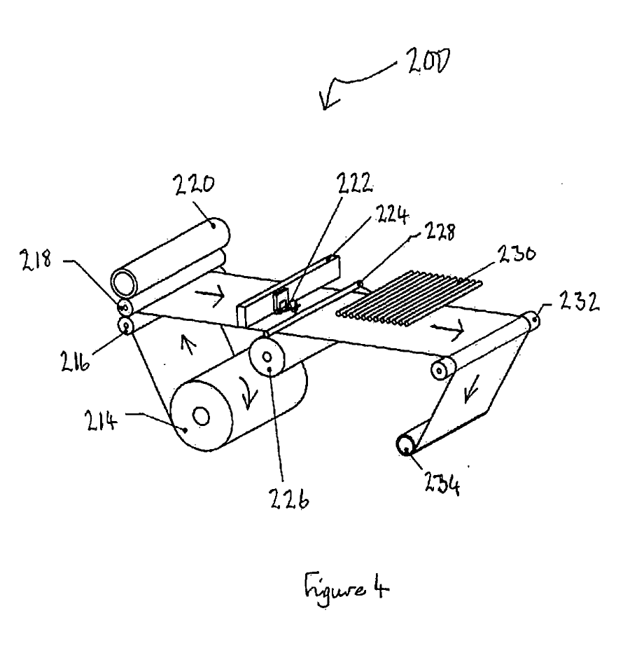

FIG. 4 represents an apparatus 200 that is very similar to the apparatus 100. The main difference is that in the apparatus 200 the substrate 214 that is coated with a liquid wet material is in a roll form rather than a sheet. The rolled substrate 214 is passed between a support roller 216 and a cleaning roller 218. The support roller 216 and the cleaning roller 218 are urged against one another. The cleaning roller 218 is used to clean the rolled substrate 214 surface. The adhesive roller 220 removes debris and/or contaminants from the cleaning roller 218 in a similar manner to as described above. An unrolled part of the cleaned substrate 214 then passes to the coating head 222 located on a coating head traverse drive 224. Similar to above the coating head 222 moves over a supportive roller 226 and under the coating bar 228 depositing a pre-calculated bead of coating liquid. There is also a drying device 230, a drive roller 232 and a take-up roll 234.

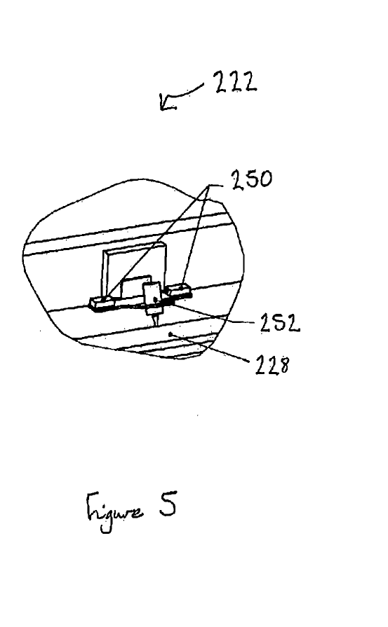

FIG. 5 is an expanded view of the coating head arrangement 222 and shows that there are coating head sensors 250 located on either side of a dispensing system 252.

The coated substrate then passes to a drying source 230 (e.g. a series of UV lamps). The apparatus 200 may also perform a reel to reel continuous process with the cured coated substrate 214 being rolled onto take-up roll 234.

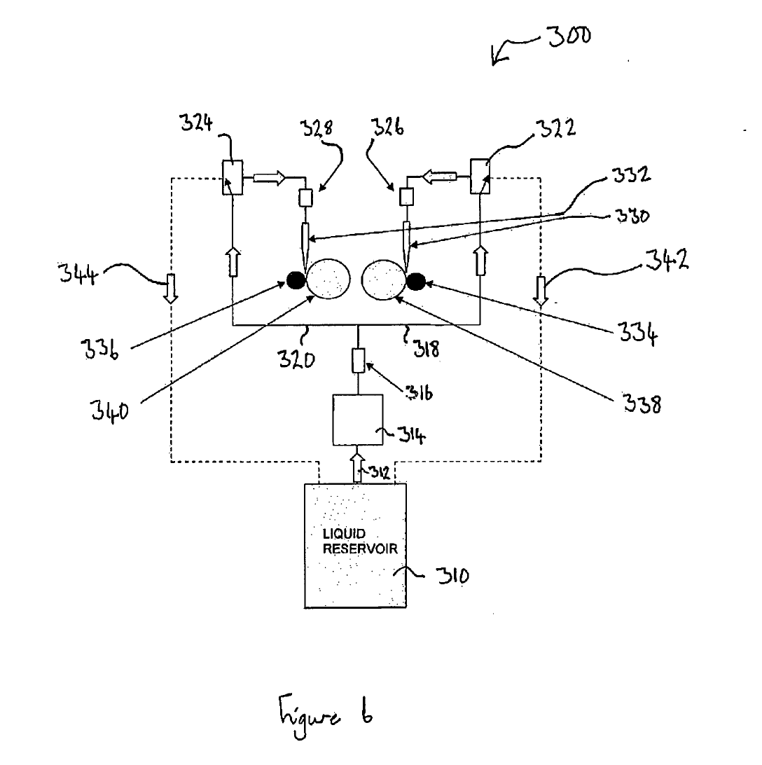

FIG. 6 is a view of apparatus 300 capable of applying liquid wet material vertically to sheets using a vertical roller coating liquid dosing system. The apparatus 300 comprises a liquid wet reservoir 310 of liquid wet material which is initially fed along outlet 312 to a pump 314. The pump 314 then feeds the liquid wet material to a pressure regulator 316. The pressure regulator 316 mitigates any pulsing from the pump 314. The liquid wet material is then split between conduits 318, 320 to respective two-position diverter valves 322, 324 which then feed the liquid wet material to flow regulators 326, 328. The flow regulators 326, 328 then feed the liquid wet material to liquid dispensing tips 330, 332 which then feed the liquid wet material onto application rollers 338, 340, respectively. Doctor rollers 334, 336 control the rate of feed. The application rollers 338, 340 are located substantially horizontal to each other. The flow regulators 326, 328 may also direct fluid back to the liquid reservoir using channels 342, 344. The liquid dispensing tips 330, 332 can be static or may traverse the application rollers 338, 340. The application rollers 338, 340 are capable of applying liquid wet material vertically to a substrate located between the application rollers 338, 340.

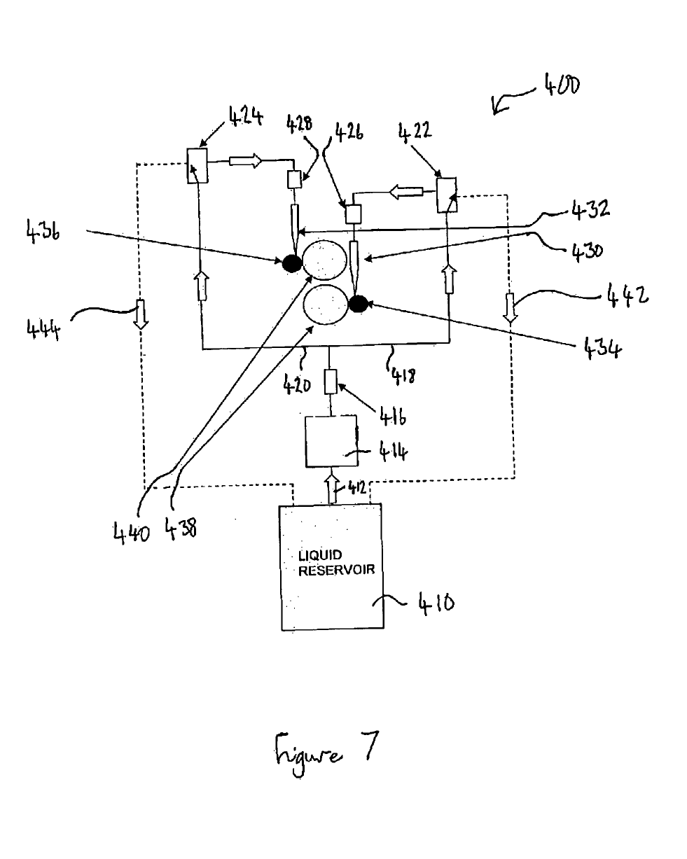

FIG. 7 is a view of apparatus 400 capable of applying liquid wet material horizontally to sheets using a horizontal roller coating liquid dosing system. The apparatus 400 comprises a liquid wet reservoir 410 of liquid wet material which is initially fed along outlet 412 to a pump 414. The pump 414 then feeds the liquid wet material to a pressure regulator 416. The pressure regulator 416 mitigates any pulsing from the pump 414. The liquid wet material is then split between conduits 418, 420 to respective two-position diverter valves 422, 424 which then feed the liquid wet material to flow regulators 426, 428. The flow regulators 426, 428 then feed the liquid wet material to liquid dispensing tips 430, 432 which then feed the liquid wet material onto application rollers 438, 440, respectively. Doctor rollers 434, 436 control the rate of feed. The application rollers 438, 440 are located substantially vertical to each other. The flow regulators 426, 428 may also direct fluid back to the liquid reservoir using channels 442, 444. The liquid dispensing tips 430, 432 can be static or may traverse the application rollers 438, 440. The application rollers 438, 440 are capable of applying liquid wet material horizontally to a substrate located between the application rollers 438, 440.

The liquid wet material may be applied to any suitable substrate such as a film which may be in laminated form.

The apparatus as described in the present invention can also be fully contained in a self-contained mini-clean room which therefore provides significant cost savings in the drying process.

Whilst specific embodiments of the present invention have been described above, it will be appreciated that departures from the described embodiments may still fall within the scope of the present invention. For example, any suitable type of imageable substrate may be formed. Moreover, any suitable liquid wet material or combinations thereof may be used. The drying device may use any form of drying which is capable of curing/drying the liquid wet material.

1-26. (canceled)

27. An apparatus for directly coating a liquid onto a substrate, said apparatus comprising:
conveying means capable of conveying a substrate to a device capable of directly coating liquid wet material onto a surface of a substrate to form a film of liquid wet material;
a sensing system capable of determining the area to be coated with the liquid wet material; and
conveying the substrate with the film of liquid wet material to a drying device capable of drying the liquid wet material on the substrate.

28. The apparatus of claim 27, wherein a programmable traversing dispensing head facilitates controlled dispensing of the liquid wet material with respect to size, shape, position, quantity, width and/or length.

29. The apparatus of claim 27, wherein by directly depositing the liquid wet material means that only the amount required for coating the substrate is supplied.

30. The apparatus of claim 27, wherein the device capable of depositing a liquid wet material comprises a coating head which is situated on a coating head transverse drive and the coating head deposits liquid wet material.

31. The apparatus of claim 27, wherein the device capable of depositing a liquid wet material also comprises coating head sensors capable of locating the edges of the substrate to be coated and limiting the action of the dispensing head to ensure that the coating liquid is dispensed only within the boundary of the material to be coated.

32. The apparatus of claim 27, wherein the device capable of depositing a liquid wet material further comprises a liquid dispensing tip which is capable of dispensing liquid in a controlled manner in the area in front of a tangential point where the coating bar makes contact with the substrate, and wherein the device capable of depositing a liquid wet material further comprises a dispensing head which tracks across the coating bar and the dispensing head is activated with pneumatics and/or electrics and dispenses a pre-calculated bead of coating liquid onto a tangential point where the coating bar makes contact with the substrate.

33. The apparatus of claim 27, wherein the device capable of directly depositing a liquid wet material comprises a set of application rollers located substantially vertical or horizontal to one another depending on whether vertical or horizontal deposition of liquid wet material is required onto the substrate, and
wherein the device capable of directly depositing a liquid wet material further comprises a pump capable of feeding liquid wet material to a pressure regulator and a two-way diverter valve capable of directing the liquid wet material for application to a substrate back to a reservoir.

34. The apparatus of claim 33, wherein the device capable of directly depositing a liquid wet material further comprises liquid dispensing tips which are static or traverse the application rollers or coating bar.

35. The apparatus of claim 27, wherein the substrate is in the form of a separate sheet or in reel form, and wherein the drying device is a radiation source or any other energy source.

36. The apparatus of claim 27, wherein the conveying apparatus is capable of conveying the substrate from one side of the apparatus to the other, and wherein the conveying apparatus comprises a support roller, a cleaning roller, a take-up roller and a drive roller onto which the conveyor is capable of being driven onto.

37. The apparatus of claim 36, wherein as the drive roller rotates the conveyor is rotated from the roll over the support roll and the along the length of the apparatus and over the drive roller and onto the take-up roll.

38. The apparatus of claim 27, wherein when the substrate is supplied in a roll form, the rolled substrate is initially passed between a support roller and a cleaning roller wherein the cleaning roller is used to clean a surface of the rolled substrate, and wherein an adhesive roller removes debris and/or contaminants from the cleaning roller and the cleaned substrate is then passed to a device capable of depositing a liquid wet material using a reel to reel process.

39. The apparatus of claim 38, wherein the support roller is substantially cylindrical in shape and is made of any suitable plastics/composite or metal material and the cleaning roller is also substantially cylindrical in shape and is made from any suitable rubber or elastomeric type of material which is capable of removing debris and/or contaminants from a substrate surface to be cleaned.

40. The apparatus of claim 27, wherein the substrate in the form of a separate sheet or an unrolled part of the substrate in reel form is passed under the coating bar forming part of the device capable of depositing a liquid wet material, and wherein the substrate is in the form of a web.

41. The apparatus of claim 27, wherein the substrate comprises a cladding made from a conductive material.

42. The apparatus of claim 27, wherein the liquid wet material is deposited with a thickness according to any of the following: less than or equal to about 150 μm; less than or equal to about 125 μm; less than or equal to about 100 μm; less than or equal to about 75 μm; less than or equal to about 50 μm; less than or equal to about 25 μm; less than or equal to about 10 μm; less than or equal to about 5 μm; less than or equal to about 1 μm; less than or equal to about 0.5 μm or less than or equal to about 0.1 μm.

43. The apparatus of claim 27, wherein the liquid wet material is deposited with a thickness ranging from any of the following: about 177 μm to about 0.1 μm; about 125 μm to about 0.1 μm; about 100 μm to about 0.1 μm; about 75 μm to about 0.1 μm; about 50 μm to about 0.1 μm; about 25 μm to about 0.1 μm or about 10 μm to about 0.1 μm.

44. The apparatus of claim 27, wherein when the substrate is supplied in a roll form the apparatus performs a reel to reel continuous process with the substrate comprising the cured/dried coating being rolled onto a take-up roll.

45. Coated substrates formed using the apparatus of claim 27.

46. A method for directly coating a liquid onto a substrate, said method comprising:
providing conveying means capable of conveying a substrate to a device capable of directly coating liquid wet material onto a surface of a substrate to form a film of liquid wet material;
providing a sensing system capable of determining the area to be coated with the liquid wet material; and
conveying the substrate with the film of liquid wet material to a drying device capable of drying the liquid wet material on the substrate.
